(19) United States
(12) Patent Application Publication
(10) Pub. No.: US 2001/0022704 A1
(43) Pub. Date: Sep. 20, 2001

(54) METHOD AND SYSTEM FOR PROVIDING A BOTTOM ARC LAYER THAT CAN ACT AS A WRITE GAP OR SEED LAYER FOR A WRITE HEAD

(75) Inventor: LIUBO HONG, SAN JOSE, CA (US)

Correspondence Address: JOSEPH A SAWYER JR, SAWYER & ASSOCIATES, P O BOX 51418, PALO ALTO, CA, 94303

(73) Assignee: Read-Rite Corporation

(21) Appl. No.: 09/325,007

(22) Filed: Jun. 2, 1999

(51) Int. Cl. G11B 5/147

(52) U.S. Cl. 360/126

(57) ABSTRACT

A method and system for a write head is disclosed. The method and system include the steps of providing a first pole and providing a bottom antireflective coating (BARC) layer. The BARC layer is conductive, nonmagnetic, and an antireflective coating. A portion of the BARC layer is disposed above the first pole. The method and system also include providing a photoresist structure having a trench therein. The method and system also include providing a second pole. A portion of the second pole is disposed above the portion of the BARC layer and within the trench. Thus, the width of the pole may be better controlled.

### FIELD OF THE INVENTION

The present invention relates to magnetic recording technology and more particularly to a thin film magnetic write head which has an improved track width and to a method and system for providing a bottom antireflective coating layer that can also act as a portion of a write gap or seed layer for a write head.

### BACKGROUND OF THE INVENTION

Magnetic data is typically stored on a magnetic recording medium, such as a disk, using a conventional write head. The conventional write head may be a separate head, but is typically part of a conventional merged head. The conventional merged head also typically includes a read head for reading magnetic data. The conventional write head is typically an inductive head, including first and second poles. The first and second poles are separated by the write gap. The write head also typically includes coils which, when energized using a current, cause the first and second poles to generate a magnetic field in the write gap. When brought into proximity with the disk or other recording media, the magnetic field writes data to the disk.

The areal density of the data written to the disk or other magnetic recording media determines how much information can be stored on the disk or other recording media. It is desirable to have a higher areal density to increase the information stored on the recording media. The track width determines the width of the bits written by the conventional write head. To control the areal density, the track width of the conventional write head is controlled. In order to control the track width, the width of a portion of the first or the second pole next to the write gap is controlled.

In order to form the second pole, photolithography is typically used. A photoresist structure is formed, typically after the write gap has been deposited. To form the photoresist structure, a layer of photoresist is provided. The photoresist is masked, exposed to light where a trench is desired to be formed, and developed. The photoresist structure thus includes the trench. The second pole is then deposited in the trench. The width of the second pole and, therefore, the track width are set by the width of the trench. The photoresist may then be stripped away. The seed layer and gap layer are then etched so that their profiles more closely match that of the second pole.

Although the conventional method for providing the conventional write head functions, the width of the conventional write head at higher areal densities may not be well controlled. For example, it is currently desirable for the width of the second pole to be on the order of 0.5 to 0.75 μm. The height of the second pole is desired to be approximately three micrometers. Thus, the aspect ratio, or height divided by width, of the second pole is very high. Furthermore, although the pole is desired to be approximately three micrometers tall, etching the seed layer and gap removes portions of the second pole. The aspect ratio of the second pole as deposited is even higher. In order to ensure that the second pole can be deposited, the trench in the photoresist must be at least as deep as the thickness of the second pole, as deposited, and as wide as the second pole.

This high aspect ratio of the second pole and the trench may make the width of the trench in the photoresist structure difficult to control. In particular, a swing curve effect and resist notching become significant. The swing curve effect occurs when the trench is formed in the photoresist. Light reflecting off the interface between the photoresist and the underlayer of the conventional write head interferes with the incident light and causes standing waves in the photoresist. This causes a sinusoidal change in the trench width as a function of the photoresist thickness. Resist notching, which also occurs during formation of the trench, is due to light reflecting off of sloped surfaces under the photoresist. Portions of the sidewalls of the trench are exposed to this reflected light. Notches or flares are thus formed in the sidewalls of the trench. Consequently, the width of the trench is not well controlled due to resist notching and the swing curve effect. The width of the second pole can vary because the width of the trench can vary. Furthermore, removal of portions of the second pole during etching of the seed layer and write gap may also change the width of the second pole. Although these effects may be negligible at higher track widths, reduction in the track width increases the effect of the variations in the width of the second pole. As a result, the track width of the conventional write head may not be well controlled at higher areal densities.

Various schemes have been proposed to improve the control over the width of the trench and, therefore, the track width of the conventional write head. Use of a conventional organic bottom antireflective coating (BARC) layer beneath the photoresist has been proposed. However, such a conventional BARC layer has to be etched prior to formation of the second pole. Etching the conventional BARC layer would also etch a portion of the sidewalls of the trench. Consequently, the width of the trench may not be well controlled. Alternatively, the photoresist structure including the trench can be formed prior to deposition of the write gap and seed layer. This reduces the height required by the pole and the change in width due to etching of the write gap and seed layer. However, variations in the width of the trench due to resist notching and the swing curve effect are still present. Consequently, the width of the second pole may still be poorly controlled. Thus, the track width for the conventional write head is not well controlled.

Accordingly, what is needed is a system and method for improving control of width of the second pole and, therefore, the track width of the write head. It would also be desirable if the method and system simplified processing of the head. The present invention addresses such a need.

### SUMMARY OF THE INVENTION

The present invention provides a thin film magnetic write head with improved track width control and a method for building the write head. The method and system comprise providing a first pole and providing a bottom antireflective coating (BARC) layer. The BARC layer is also conductive and nonmagnetic. A portion of the BARC layer is disposed above the first pole. The method and system also comprise providing a photoresist structure having a trench therein. The method and system also comprise providing a second pole. A portion of the second pole is disposed above the portion of the BARC layer and within the trench.

According to the system and method disclosed herein, the present invention provides a mechanism for better controlling the width of the second pole. The BARC layer allows sidewalls of the trench in the photoresist structure to be straighter and smoother. Furthermore, the BARC layer does not need to be removed prior to providing the second pole. Thus, the width of the portion of the second pole within the trench is better controlled. As a result, the track width of the write head formed is better controlled.

### BRIEF DESCRIPTION OF THE DRAWINGS

FIG. 1A is a diagram of a side view conventional merged head including a write head and a read head.

FIG. 1B is a diagram of an air bearing surface view of a conventional merged head including a write head and a read head.

FIG. 2A is a flow chart of one conventional method for providing the write head.

FIG. 2B is a diagram of the conventional write head during fabrication.

FIG. 3A is a flow chart of a second conventional method for providing the write head.

FIG. 3B is a diagram of the conventional write head after the resist structure has been provided during the second conventional method for providing the conventional write head.

FIG. 3C is a diagram of the conventional write head after the organic BARC layer has been removed in the second conventional method for providing the conventional write head.

FIG. 4A is a flow chart of a third conventional method for providing the write head.

FIG. 4B s a diagram of the conventional write head during fabrication using the third conventional method.

FIG. 5 is a diagram of a side view first embodiment of a merged head including a read head and a write head in accordance with the present invention.

FIG. 6A is a flow chart of one embodiment of a method for providing the first embodiment of the write head in accordance with the present invention.

FIGS. 6B-F are diagrams depicting the air bearing surface views of first embodiment of the head in accordance with the present invention during fabrication.

FIG. 7 is a diagram of a side view of a second embodiment of a merged head including a read head and a write head in accordance with the present invention.

FIG. 8A is a flow chart of one embodiment of a method for providing the second embodiment of the write head in accordance with the present invention.

FIGS. 8B-G are diagrams depicting air bearing surface views of the second embodiment of the head in accordance with the present invention during fabrication.

FIG. 9 is a diagram of a third embodiment of a merged head including a read head and a write head in accordance with the present invention.

FIG. 10A is a flow chart of one embodiment of a method for providing the third embodiment of the write head in accordance with the present invention.

FIGS. 10B-F are diagrams depicting air bearing surface views of the third embodiment of the head in accordance with the present invention during fabrication.

FIG. 11 is a flow chart depicting a method for providing the BARC layer in accordance with the present invention.

FIG. 12A is a diagram of a first alternate embodiment of the write head in accordance with the present invention.

FIG. 12B is a diagram of a second alternate embodiment of the write head in accordance with the present invention.

FIG. 12C is a diagram of a third alternate embodiment of the write head in accordance with the present invention.

### DETAILED DESCRIPTION OF THE INVENTION

The present invention relates to an improvement in magnetic recording technology. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

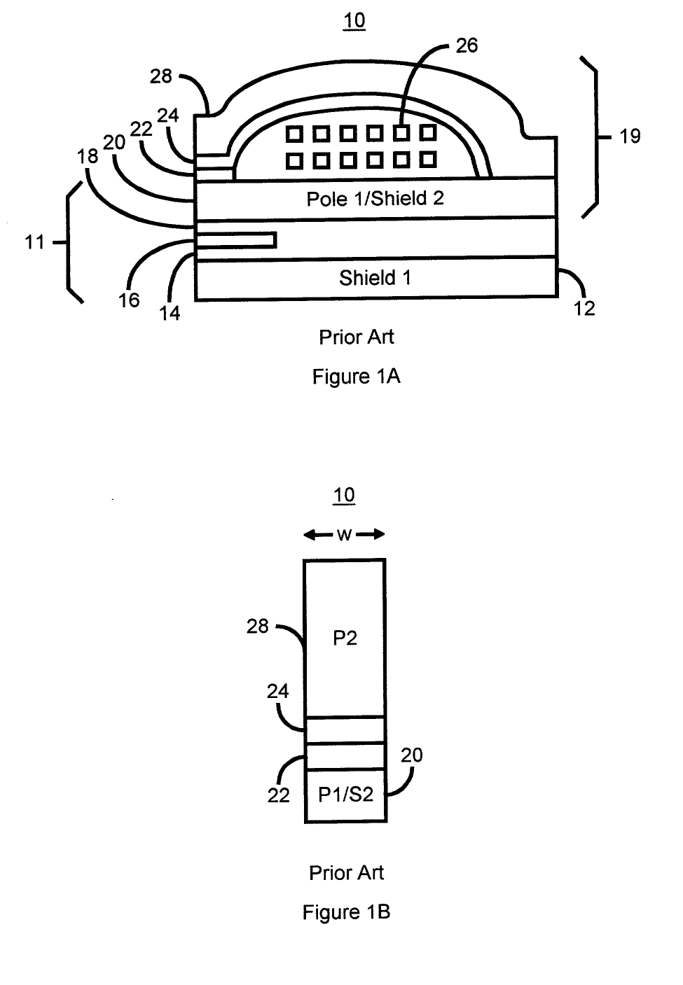

FIGS. 1A and 1B depict a conventional merged head 10. FIG. 1A is a diagram depicting a side view of a conventional merged head 10. The conventional merged head 10 includes a conventional read head 11 and a conventional write head 19. The conventional read head 11 includes a first shield 12, a first gap 14, a magnetoresistive (MR) sensor 16, and a second gap 18. The MR sensor 16 can be one of many types of MR sensors, such as an anisotropic magnetoresistance (AMR) sensor, a spin valve, a giant magnetoresistance (GMR) sensor, a dual spin valve, or other MR sensors. The conventional merged head 10 also includes a first pole/second shield (P1/S2) 20. Because it acts as a second shield, the P1/S2 20 can be considered part of the conventional read head 11. Similarly, the P1/S2 20 can be considered part of the conventional write head 19 because the P1/S2 20 acts as the first pole for the conventional write head 19. The conventional write head 19 also includes a write gap 22, a seed layer 24, coils 26, and a second pole (P2) 28.

FIG. 1B depicts an air bearing surface view of a portion of the conventional merged head 10. Thus, FIG. 1B depicts the conventional merged head 10 as seen from the air bearing surface between the conventional merged head 10 and a recording media (not shown). The width, w, of the P2 28 at the air bearing surface near the write gap 22 determines the track width of the conventional write head 19. The zero throat position is approximately where, as seen in FIG. 1A, the P1/S2 20 and the P2 28 begin to diverge. This portion of the P2 28 is depicted in FIG. 1B. Although the write head 19 is shown as trimmed, the write head 19 may not be trimmed.

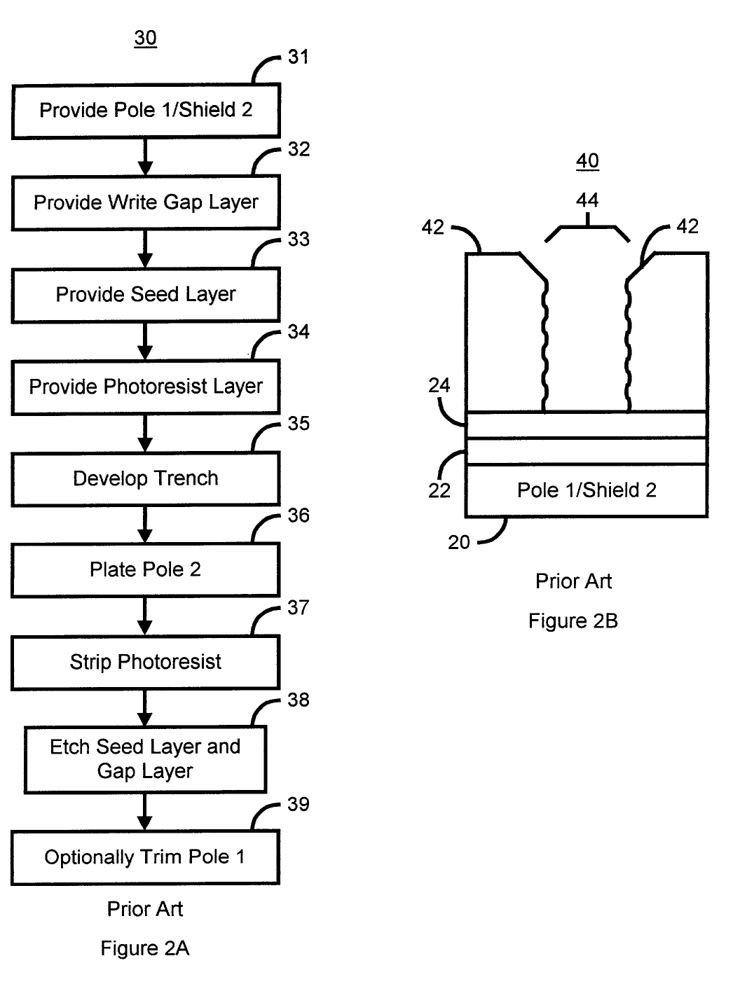

FIG. 2A is a flow chart depicting a conventional method 30 for providing the conventional write head 19. The P1/S2 20 is provided, via step 31. Typically, the P1/S2 20 is plated in step 31. The layer for the write gap 22 is then provided, via step 32. Typically, the write gap 22 is made of a nonmagnetic, insulating material. The seed layer 24 is then provided, via step 33. The seed layer 24 is used to enable the next layer of the conventional write head 19, the P2 28, to be plated with the desired crystal structure. A layer of photoresist is then spun onto the conventional write head 19, via step 34. Using photolithography, a trench is developed in the photoresist, via step 35. The second pole P2 28 is then plated, via step 36. The photoresist is then stripped, via step 37. Thus, the P2 28 which filled the trench in the photoresist remains. The seed layer 24 and write gap 22 are then etched to have the desired profile, via step 38. Step 38 is typically performed using ion milling. If desired, the P1/S2 20 is then optionally trimmed, via step 39.

Although the conventional method 30 is capable of providing the conventional write head 19, one of ordinary skill in the art will readily recognize that it is desirable for the conventional write head 19 to be able to record data at higher densities. Thus, it is desirable to decrease the track width of the conventional write head 19. In order to lower the track width of the conventional write head 10, the width of the P2 28, shown in FIG. 1B, can be decreased. For example, some generations of conventional write heads had a P2 28 width of 0.75-1 μm. It is currently desirable to reduce the width of the P2 28 even further. For example, it is currently desirable to have the P2 28 width of approximately 0.45-0.75 μm. At the same time, it is desirable to have a P2 28 height of approximately 5-6 μm when the P2 28 is deposited. This results in a P2 28 height of approximately 3-4 μm when processing is completed. Thus, the aspect ratio of the P2 28 is high.

To reduce the width of the P2 28, the width of the trench in the photoresist formed in step 35 is reduced. The trench must also be deep enough to allow sufficient material for the P2 28 to be provided without filling the trench. In other words, the aspect ratio of the trench must be higher than the aspect ratio of the P2 28. For example, for a P2 28 height of approximately 5-6 μm as deposited, the trench is typically approximately 8-9 μm thick. In addition, the etch of seed layer 24 and the write gap 22 in step 38, depicted in FIG. 2A, also changes the width and height of the P2 28. As the write gap 22 and seed layer 24 are etched, a portion of the P2 28 is etched. As a result, the P2 28 of a greater thickness than for the final P2 28 must be deposited. Thus, the trench must be made even deeper than to allow for a 3-4 μm deposition. The aspect ratio of the trench must be even higher. Furthermore, the topography of the conventional write head 19 below the seed layer varies in height. One of ordinary skill in the art will readily recognize that these conditions make the width of the P2 28 difficult to control. Moreover, the etch of the seed layer 24 and write gap 22 may also decrease the width of the P2 28, reducing the control over the width of the P2 28.

To understand how the high aspect ratio of the P2 28 affects the control of the width of the P2 28, refer to FIG. 2B. FIG. 2B depicts an air bearing surface view of a portion 40 of the conventional write head 19 during fabrication. The portion 40 depicted is shown after the trench has been developed in step 35 of the method 30, shown in FIG. 2A. Referring back to FIG. 2B, P1/S2 20, the layer for the write gap 22, and the seed layer 24 have been deposited. In addition, the photoresist structure 42 including a trench 44 has been provided. The trench has a width of approximately w. Because of the high aspect ratio, the relatively small width of the trench 44, and the topography beneath the photoresist structure 42, the width of the trench 44 varies. In addition, flares at the top of the trench 44 are developed. The variation in the width of the trench 44 is due to the swing curve effect and resist notching.

The swing curve effect occurs when the trench 44 is formed. Light used to form the trench 44 reflects off of portions of the conventional write head 19 that are under the layer of photoresist 42. For example, light may reflect off of the seed layer 24, which is very reflective. The reflected light interferes with the incident light and causes standing waves in light intensity in the photoresist 42. Thus, the swing curve effect causes variations in the width of the trench 44 which depend upon the thickness of the photoresist. Resist notching also occurs during formation of the trench 42. Light reflects off of sloped surfaces under the photoresist 42 and strikes the sidewalls of the trench 44. These portions of the sidewalls of the trench 44 are removed during processing, forming notches in the sidewalls of the trench 44.

Thus, the swing curve effect and resist notching change the width of the trench 42. At higher widths, the swing curve effect and resist notching may not greatly affect the width of the trench 44. However, as the width of the P2 28 and the trench 44 decreases, the swing curve effect and resist notching cause a greater fractional change in the width of the trench 44. Furthermore, the resist notching becomes more pronounced at higher aspect ratios of the trench 44 and with a higher stack height for the head 10. Consequently, the width of the trench 44 is not well controlled due to resist notching and the swing curve effect as well as due to the etch of the seed layer 24 and the write gap 22.

Because the width of the trench 44 is not well controlled, the width of the P2 28 may not be well controlled. Similarly, the etch of the seed layer 24 and the write gap 22 also etches the P2 28. As a result, the track width of the conventional write head 19 may be poorly controlled. When the track width is not well controlled, the conventional write head 19 may inadvertently write tracks other than the track that is currently desired to be written. Writing one track may affect data on other tracks. Thus, the data may not be stored or read correctly, which is undesirable.

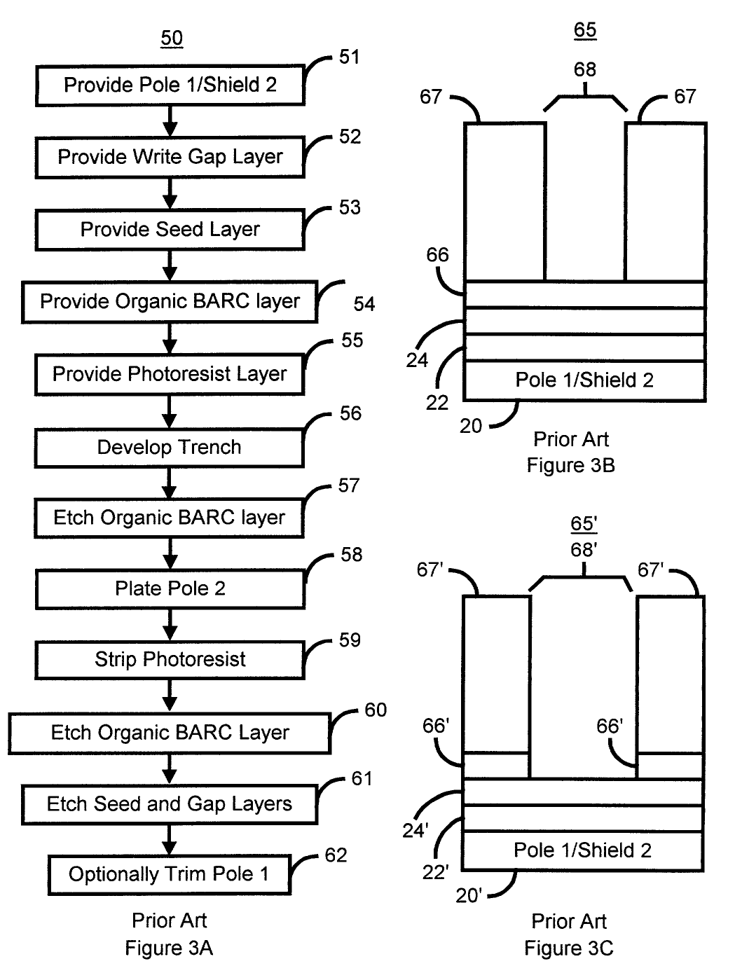

FIG. 3A is a flow chart depicting another conventional method 50 for providing the conventional write head 19. The method 50 reduces variations in the width of the P2 28 due to the swing curve effect and resist notching. The P1/S2 (first pole/second shield) 20 is provided via step 51. Typically, the P1/S2 20 is plated in step 51. The layer for the write gap 22 is then provided, via step 52. Typically, the write gap 22 is made of a nonmagnetic, insulating material. The seed layer 24 is then provided, via step 53. A conventional, organic bottom antireflective coating (BARC) layer is then provided, via step 54. For example, an organic BARC layer may be spun onto the seed layer 24 in step 54. The combination of the thickness and optical properties of conventional organic BARC layer provided in step 54 reduces or eliminates light reflecting off of the seed layer 24.

A layer of photoresist is then spun onto the conventional organic BARC layer, via step 55. Using photolithography, a trench is developed in the photoresist, via step 56. The exposed portion of the conventional organic BARC layer is then etched, via step 57. The conventional organic BARC layer is etched so that the P2 (second pole) 28 can be plated onto the seed layer 24. If the conventional organic BARC layer is not etched, P2 may not be plated. Once the conventional organic BARC layer is etched, the second pole P2 28 is then plated, via step 58. The photoresist is then stripped, via step 59. Thus, the P2 28 which filled the trench in the photoresist remains. The conventional organic BARC layer is then etched, via step 60. The seed layer 24 and write gap 22 are then etched to have the desired profile, via step 61. Step 61 is typically performed using ion milling. If desired, the P1/S2 20 is then optionally trimmed, via step 62.

Although the use of the conventional organic BARC layer reduces the swing curve effect and resist notching, one of ordinary skill in the art will readily realize that the conventional organic BARC layer introduces other problems. FIGS. 3B and 3C depict a portion 65 of the conventional write head 19 during fabrication using the method 50. FIG. 3B depicts an air bearing surface view of the portion 65 of the conventional write head 19. The photoresist 67 including the trench 68 has been provided. In addition, a conventional organic BARC layer 66 has been provided. Because of the conventional organic BARC layer 66, the variation in the width of the trench 68 is reduced. Although reflected light and variations in the width of the trench 68 are decreased, the conventional organic BARC layer 66 is spun on. Consequently, the conventional organic BARC layer 66 may not be evenly distributed over the exposed surfaces of the conventional write head 19. The ability of the conventional organic BARC layer 66 to reduce reflections varies as the thickness of the conventional organic BARC layer varies. Thus, the conventional organic BARC layer 66 may not reduce reflections and variations in the width of the trench 66 as much as desired.

Furthermore, a portion of the conventional organic BARC layer 66 must be removed prior to deposition of the P2 28. FIG. 3C depicts the portion 65′ of the conventional write head 19 after the conventional organic BARC layer 66′ in the trench 68′ has been removed. The conventional organic BARC layer 66′ is typically anisotropically etched to primarily remove the horizontal surface of the conventional organic BARC layer 66′. However, during the etch, a portion of the sidewalls of the trench 68′ are removed. For a poor quality of the anisotropic etch, more material is removed from the sidewalls of the trench 68′. Consequently, the width of the trench 68′ may not be well controlled. In addition, the etch of the conventional organic BARC layer 66′ may damage the seed layer 24′. Damage to the seed layer 24′ may cause difficulty in plating the P2 28 (not shown in FIG. 3C) or change the magnetic properties of the P2 28. Consequently, a poor quality P2 28 may be grown. Thus, the conventional method 50 depicted in FIG. 3A may result in a P2 28 having a width which is poorly controlled and which may not have the desired magnetic properties.

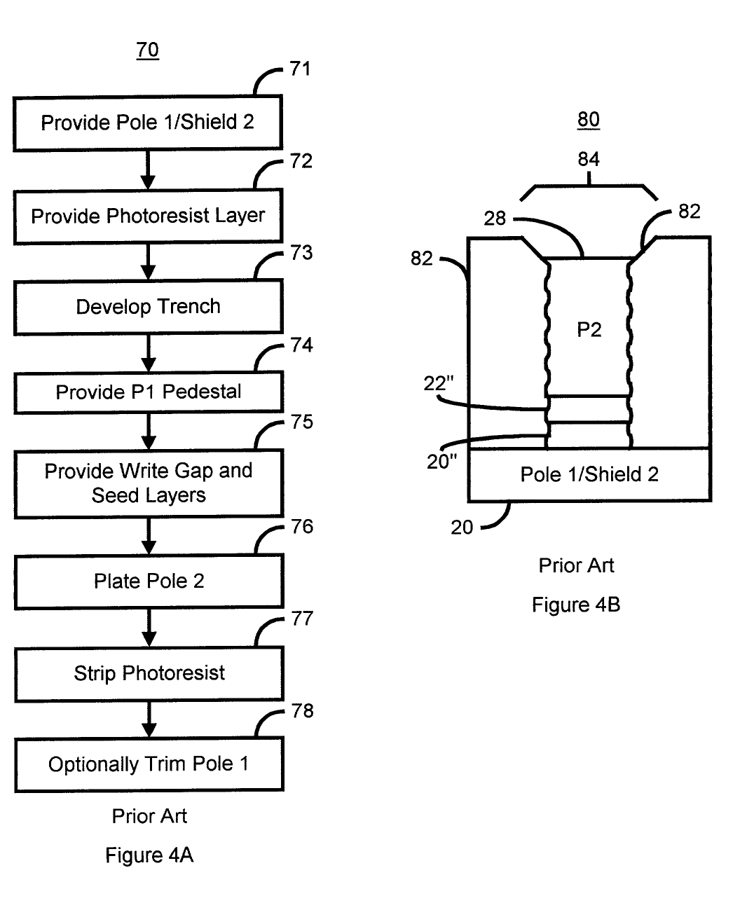

FIG. 4A is a flow chart depicting a third conventional method 70 for providing the conventional write head 19. FIG. 4A will be described in conjunction with FIG. 4B, which depicts a portion 80 of the conventional write head 19 after deposition of the P2 28. The method 70 depicted in FIG. 4A reduces variations in the width of the P2 28 due to the etch of the BARC layer 66 and the etch of the seed layer 24 and the write gap 22. The P1/S2 (first pole/second shield) 20 is provided via step 71. Typically, the P1/S2 20 is plated in step 71. A layer of photoresist is then spun onto the P1/S2 20, via step 72. Using photolithography, a trench is developed in the photoresist, via step 73. A pedestal 20″ for the P1 may then be provided, via step 74. A write gap layer/seed layer 22″ is then provided, via step 75. Typically, the write gap/seed layer 22″ is made of a nonmagnetic, conductive material. The write gap/seed layer 22″ also acts as the seed layer for the next layer, P2 28. The second pole P2 28 is then plated, via step 76. The photoresist is then stripped, via step 77. Thus, the P1 pedestal 20″, the write gap/seed layer 22″ and the P2 28 which filled the trench in the photoresist remains. If desired, the P1/S2 20 is then optionally trimmed, via step 78.

Because write gap/seed layer 22′ need not be removed, variations in the width of the P2 28 due to this etch are eliminated. Furthermore, changes in the height of the pole due to removal of portions of the write gap 22 and the seed layer 24 are reduced. In addition, because no conventional organic BARC layer is provided, there is not etch of the conventional organic BARC layer. Thus, the variations in the width of the P2 28 due to the etch of a conventional organic BARC layer are avoided. Consequently, the width of the P2 28 is somewhat better controlled.

Although the width of the P2 28 is somewhat better controlled, one of ordinary skill in the art will readily realize that the P2 28 may still have significant variations in width. FIG. 4B depicts a portion 80 of the conventional write head 19 after deposition of the P2 28. The P2 28, the write gap/seed layer 22″, and the P1 pedestal 20″ are all within the trench 84 in the photoresist structure 82. Because light can still reflect off of the underlying portions of the conventional write head 19, the swing curve effect and resist notching are still present. Thus, the trench 84 still varies in width. The P1 pedestal 20″, the write gap/seed layer 22″, and the P2 28 thus all vary in width. Consequently, conventional method 70 may still result in significant variations in the width of the P2 28. Thus, the performance of the conventional write head 19 may be undesirable.

The present invention provides a method and system for providing a write head. The method and system comprise providing a first pole and providing a bottom antireflective coating (BARC) layer. The BARC layer is also conductive and nonmagnetic. A portion of the BARC layer is disposed above the first pole. The method and system also comprise providing a photoresist structure having a trench therein. The method and system also comprise providing a second pole. A portion of the second pole is disposed above the portion of the BARC layer and within the trench.

The present invention will be described in terms of a merged head having specific components. However, one of ordinary skill in the art will readily recognize that this method and system will operate effectively for other write heads. Similarly, one of ordinary skill in the art will readily recognize that the present invention will operate effectively for other configurations of write heads. The present invention will also be described in the context of specific materials. However, one of ordinary skill in the art will readily realize that the present invention can be used with other materials having the desired characteristics.

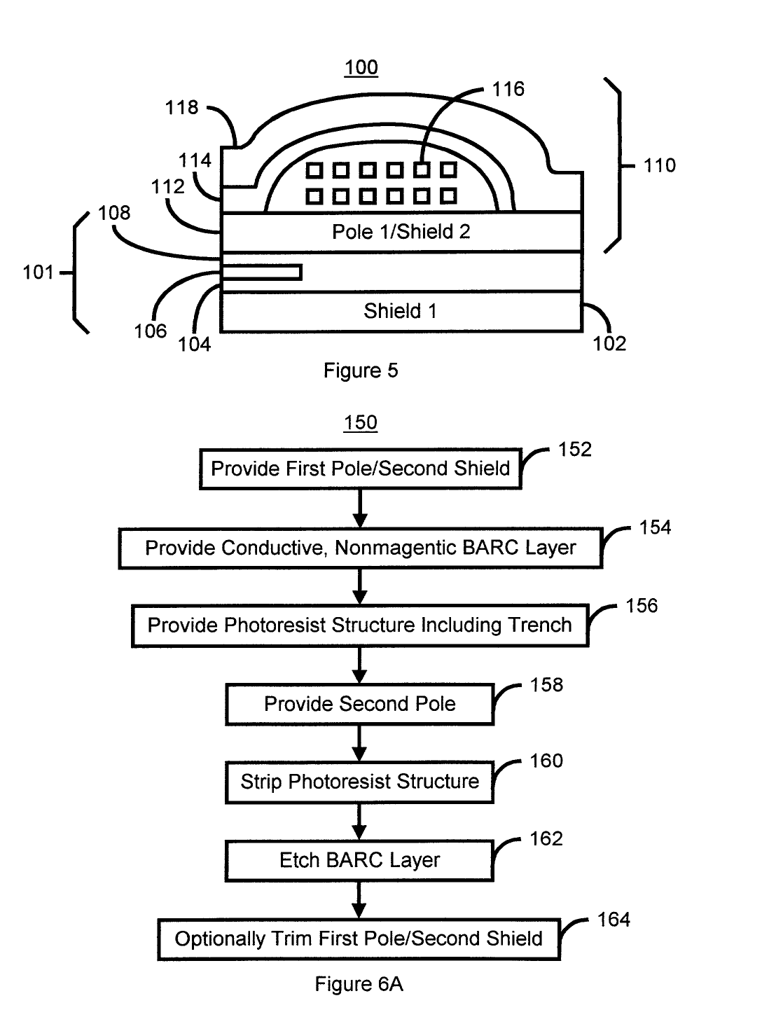

To more particularly illustrate the method and system in accordance with the present invention, refer now to FIG. 5, depicting a side view of one embodiment of a write head 110 in accordance with the present invention. The write head 110 is part of a merged head 100 which includes the write head 110 and a read head 101. The read head 101 includes a first shield 102, a first gap 104, a read sensor 108, a second gap 108, and the first pole/second shield (P1/S2) 112. The P1/S2 112 is also part of the write head 110. The write head 110 also includes a bottom antireflective coating (BARC) layer 114, a second pole (P2) 118, and at least one coil 116. The BARC layer 114 is a conductive, nonmagnetic layer. In the write head 110 shown, the BARC layer 114 can reduce or eliminate reflections during processing. In addition, the BARC layer 114 can function as the write gap during use of the write head 110 and as the seed layer for the P2 118. In a preferred embodiment, the BARC layer 114 is TiN. In an alternate embodiment, WN_{X} might be a suitable material for the BARC layer 114.

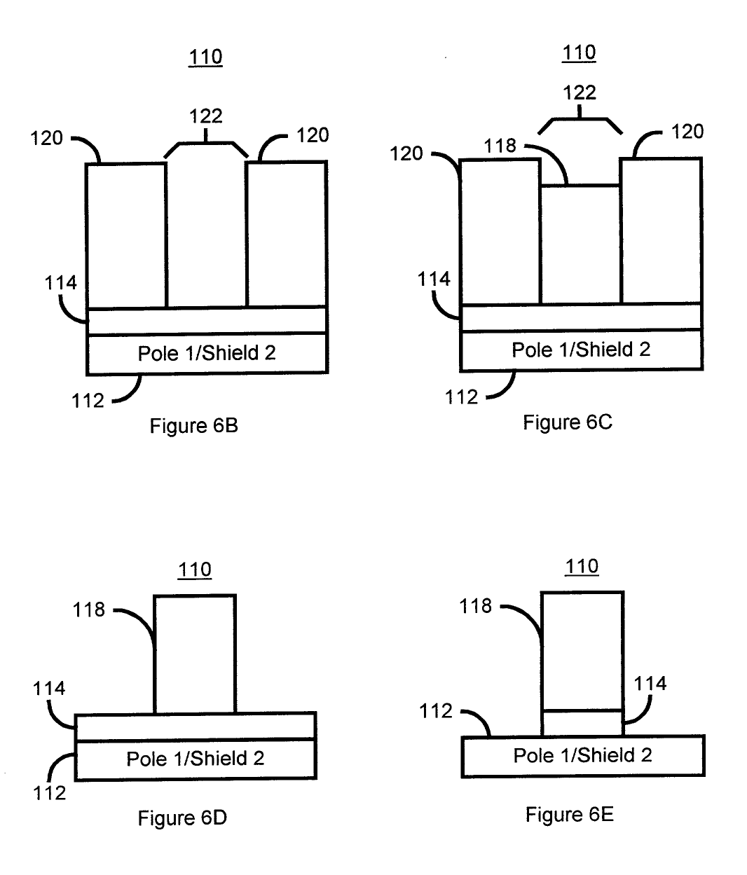

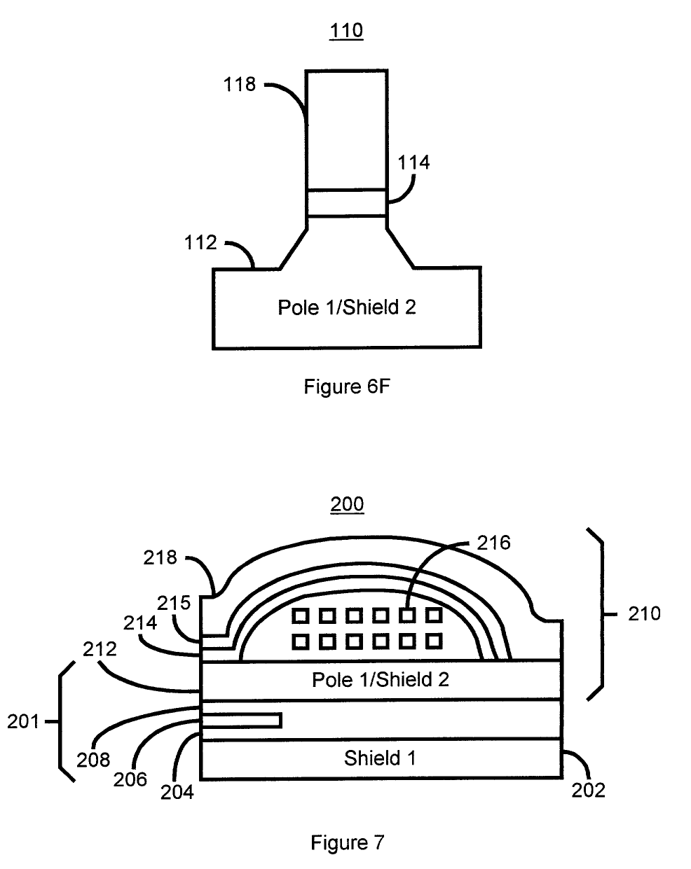

One embodiment of a method for forming the write head 110 will be described in conjunction with FIGS. 6A-6F. FIG. 6A is a flow chart depicting one embodiment of a method 150 for providing the write head 110. FIGS. 6B-6F depict an air bearing surface view of the write head 110 at various points during fabrication. Referring to FIG. 6A, the P1/S2 (first pole/second shield) 112 is provided via step 152. Preferably, the P1/S2 212 is plated in step 152. The BARC layer 114 is provided, via step 154. The BARC layer 114 is preferably deposited in step 154 by physical vapor deposition (PVD) or chemical vapor deposition (CVD). In one embodiment, the thickness of the BARC layer 114 is chosen to minimize reflections. In a preferred embodiment, the thickness of the BARC layer 114 is chosen to optimize the write gap. In another embodiment, the BARC layer 114 is chosen to attempt to optimize the combination of providing the desired thickness write gap while reducing reflections. In all embodiment, however, the BARC layer 114 should reduce reflections. A photoresist structure including a trench is then provided, via step 156. Preferably, the photoresist structure is provided by spinning a layer of photoresist onto the BARC layer 114 and developing the trench using photolithography.

FIG. 6B depicts the write head 110 after step 156 has been performed. The photoresist structure 120 including the trench 122 is above the P1/S2 112 and the BARC layer 114. The BARC layer 114 is preferably made of TiN. The BARC layer 114 reduces reflections from the portions of the write head 110 under the photoresist structure 120. The BARC layer 114 preferably accomplishes this by having the appropriate optical properties and thickness to allow for destructive interference for light reflected off of the top surface of the BARC layer 114 and light reflected off of the bottom surface of the BARC layer 114. Because the BARC layer 114 reduces the light reflected from the portions of the write head 110 under the photoresist structure 120, the variations in the width of the trench due to resist notching or the swing curve effect can be reduced or eliminated.

Referring back to FIG. 6A, the P2 118 is then provided, via step 158. In a preferred embodiment, the P2 118 is plated onto the BARC layer 114. In the write head 110, therefore, the BARC layer 114 has an appropriate structure for acting as the seed layer for the P2 118. The photoresist structure 120 is then stripped, via step 160. FIGS. 6C and D depict the write head 110 after the P2 118 has been deposited and after the photoresist structure 120 has been stripped, respectively. Because the variations in the width of the trench have been reduced by the BARC layer 114, the P2 118 has a better controlled width.

Referring back to FIG. 6A, the BARC layer 114 is then etched, via step 162. In a preferred embodiment step 162 is performed using a reactive ion etch (RIE). The P1/S2 may then be optionally trimmed, via step 164. FIGS. 6E and 6F depict the write head 110 without trimming and with trimming, respectively. Because the BARC layer 114 is used, the variations in the width of the P2 118 due to resist notching and the swing curve effect can be substantially reduced or eliminated. Thus, the track width for the write head 110 in accordance with the present invention is better controlled. Because the BARC layer 114 can act as the seed layer for the P2 118, the BARC layer 114 need not be stripped prior to deposition of the P2 118. Consequently, the variations in the width of the P2 118 due to an etch and degradations in the quality of the P2 118 due to damage to a seed layer may be reduced or avoided. The write head 110 may thus have improved performance, particularly at higher densities. Furthermore, only a single BARC layer 114 is etched in step 162 of the method 150. Thus, losses in the height and width of the P2 118 may be reduced. Consequently, the height of the P2 118 as deposited is closer to the desired height of the P2 118. The aspect ratio of the P2 118 as deposited and the trench 122 may thus be reduced. In one embodiment, the trench and P2 118 may be made approximately one micrometer thinner than if the conventional organic BARC 66 is used. In addition to etching only the BARC layer 114 after the photoresist structure 120 is stripped, the step of providing and removing a portion of the conventional organic BARC layer are avoided. Thus, processing for the write head 110 is simplified. Furthermore, the BARC layer 114, which may be made of TiN or another suitable conductive, nonmagnetic material, can be plated on, allowing the P2 118 to be more easily provided. In addition, when TiN is used for the BARC layer 114, the BARC layer 114 can be more easily etched using RIE with high selectivity to the pole P2 118. Thus processing is further simplified.

FIG. 7 depicts a side view of another embodiment of a write head 210 in accordance with the present invention. The write head 210 is part of a merged head 200 which includes the write head 210 and a read head 201. The read head 201 includes a first shield 202, a first gap 204, a read sensor 206, a second gap 208, and the first pole/second shield (P1/S2) 212. The P1/S2 212 is also part of the write head 210. The write head 210 also includes a bottom antireflective coating (BARC) layer 214, a second write gap layer 215, a second pole (P2) 218, and at least one coil 216. The BARC layer 214 is a conductive, nonmagnetic layer. In the write head 210 shown, the BARC layer 214 can reduce or eliminate reflections during processing. In addition, the BARC layer 214 can function as part of the write gap during use of the write head 210. The second write gap layer 215 also functions as part of the write gap during use of the write head 210. Thus, the second write gap layer 215 is nonmagnetic and conductive. In the write head 210, the second write gap layer 215 may also act as the seed layer for the P2 218. Thus, in a preferred embodiment, the second write gap layer 215 has the desired crystal structure to be used as a seed layer for the P2 218. In a preferred embodiment, the BARC layer 214 is TiN. In an alternate embodiment, WN_{X} might be a suitable material for the BARC layer 214.

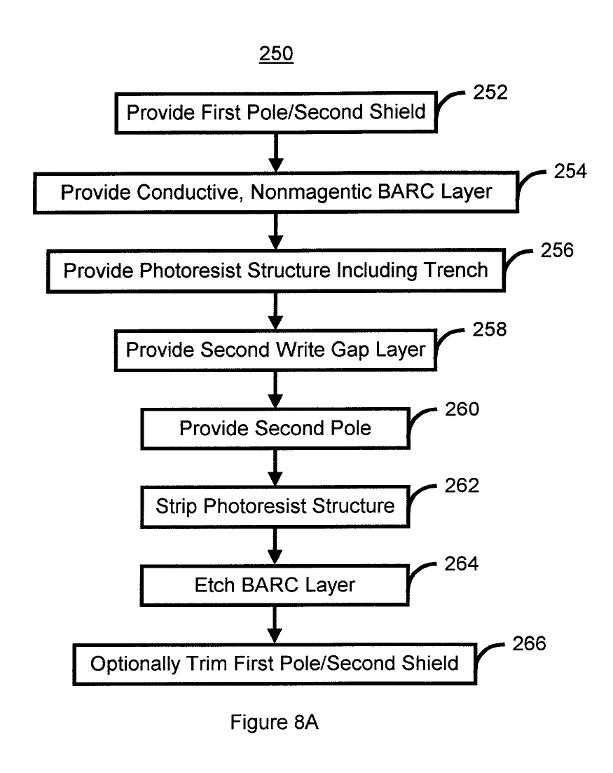

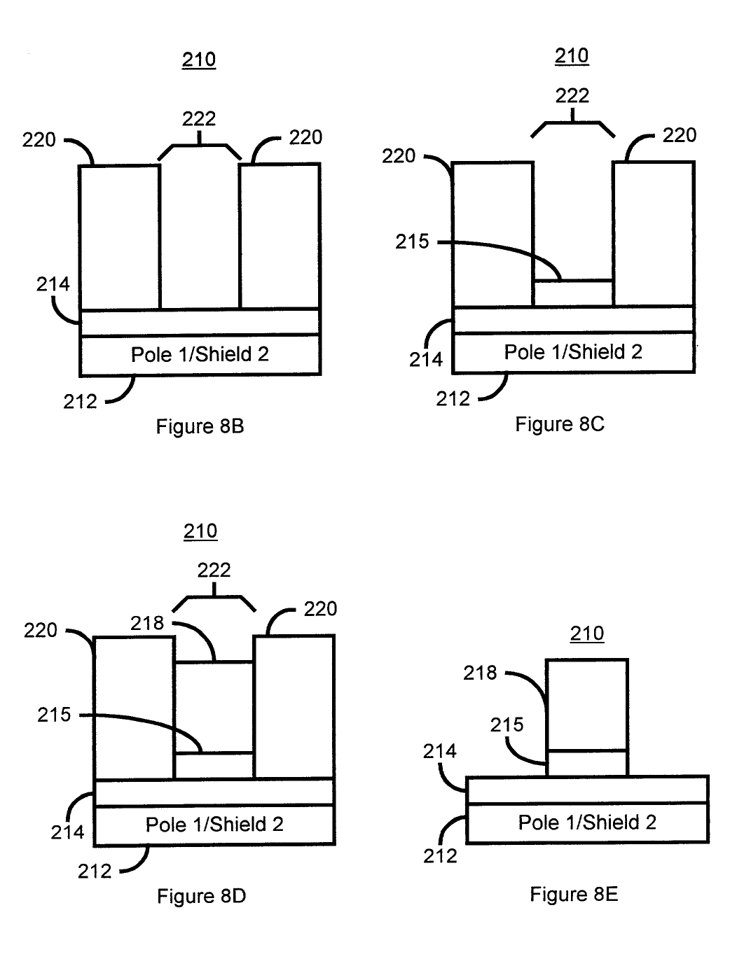

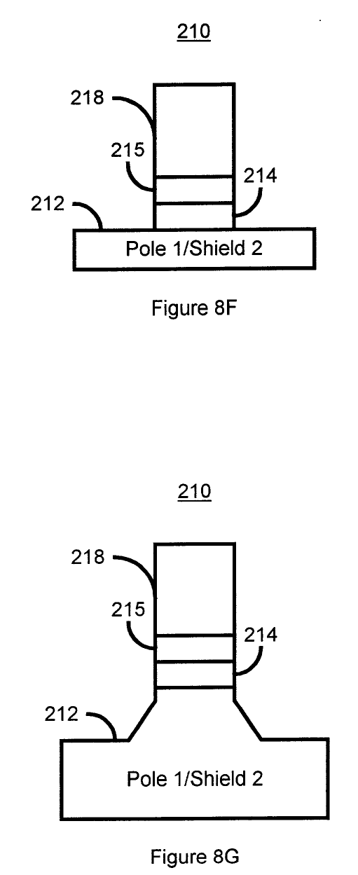

One embodiment of a method for forming the write head 210 will be described in conjunction with FIGS. 8A-8G. FIG. 8A is a flow chart depicting one embodiment of a method 250 for providing the write head 210. FIGS. 8B-8G depict an air bearing surface view of the write head 210 at various points during fabrication. Referring to FIG. 8A, the P1/S2 (first pole/second shield) 212 is provided via step 252. Preferably, the P1/S2 212 is plated in step 252. The BARC layer 214 is provided, via step 254. The BARC layer 214 is preferably deposited in step 254. The BARC layer 214 provided in step 254 preferably has the optical characteristics and thickness to substantially minimize reflections. A photoresist structure including a trench is then provided, via step 256. Preferably, the photoresist structure is provided by spinning a layer of photoresist onto the BARC layer 214 and developing the trench using photolithography.

FIG. 8B depicts the write head 210 after step 256 has been performed. The photoresist structure 220 including the trench 222 is above the P1/S2 212 and the BARC layer 214. The BARC layer 214 is preferably TiN. The BARC layer 214 reduces reflections from the portions of the write head 210 under the photoresist structure 220. The BARC layer 214 preferably accomplishes this by having the appropriate optical properties and thickness to allow for destructive interference from light reflected off of the top surface of the BARC layer 214 and light reflected off of the bottom surface of the BARC layer 214. Because the BARC layer 214 reduces the light reflected from the portions of the write head 210 under the photoresist structure 220, the variations in the width of the trench due to resist notching or the swing curve effect can be reduced or eliminated.

Referring back to FIG. 8A, the nonmagnetic second write gap layer 215 is then provided. In a preferred embodiment, the second write gap layer 215 is plated. The P2 218 is then provided, via step 260. In a preferred embodiment, the P2 218 is plated onto the second write gap layer 215. In the write head 210, therefore, the second write gap layer 215 has an appropriate structure for acting as the seed layer for the P2 218. The photoresist structure 220 is then stripped, via step 262. FIGS. 8D and E depict the write head 210 after the P2 218 has been deposited and after the photoresist structure 220 has been stripped, respectively.

Referring back to FIG. 8A, the BARC layer 214 is then etched, via step 264. In a preferred embodiment step 264 is performed using RIE. The P1/S2 212 may then be optionally trimmed, via step 266. FIGS. 8F and 8G depict the write head 210 without trimming and with trimming, respectively. Because the BARC layer 214 is used, the variations in the width of the P2 218 due to resist notching and the swing curve effect can be substantially reduced or eliminated. Thus, the track width for the write head 210 in accordance with the present invention is better controlled.

Furthermore, only a single BARC layer 214 is etched in step 264 of the method 250. Thus, losses in the height and width of the P2 218 may be reduced. Consequently, the height of the P2 218 as deposited is closer to the desired height of the P2 218. The aspect ratio of the P2 218 as deposited and the trench 222 may thus be reduced. In one embodiment, the trench and P2 218 may be made approximately one micrometer thinner than if the conventional organic BARC 266 used. In addition to etching only the BARC layer 214 after the photoresist structure 220 is stripped, the step of providing and removing a portion of the conventional organic BARC layer are avoided. Thus, processing for the write head 210 is simplified.

Use of the second write gap layer 215 may have multiple benefits. The second write gap layer 215 in conjunction with the BARC layer 214 may improve performance of the write head 210 by providing a write gap having the desired thickness along with the benefits of use of the conductive, nonmagnetic BARC layer 214. The write gap, or distance between the P1/S2 212 and the P2 218, is important in magnetic recording technology. Thus, this distance is usually relatively closely controlled. Because the second write gap layer 215 is provided, the total thickness of the write gap, which includes the second write gap layer 215 and the BARC layer 214, may be better optimized and closer to the desired thickness. At the same time, the reflections may be further reduced by the BARC layer 214. In other words, the thickness of the write gap and the thickness of the BARC layer 214 as well as the reduction in reflections and the attendant reduction in variations in the width of the P2 218 may be improved simultaneously. These benefits are achieved because the BARC layer 214 can be provided at a thickness which reduces reflections as desired while the second write gap layer 215 can be used to provide a write gap having a desired thickness. Thus, variations in the width of the P2 218 may be reduced at the same time that a more optimal write gap thickness is provided. Furthermore, as discussed above, the BARC layer 214, which may be made of TiN or another suitable conductive, nonmagnetic material, can be plated on, allowing the second gap layer 215 to be more easily provided. In addition, when TiN is used for the BARC layer 214, the BARC layer 214 can be more easily etched using reactive ion etching. Thus processing is further simplified.

In addition, the crystal structure of the P2 218 may be improved by use of the second write gap layer 215. Although the BARC layer 214 preferably has an adequate structure for use as a seed layer, the material chosen for the second write gap layer 215 may be better suited to function as a seed layer for the P2 218. For example, the P2 218 may be made of NiFe. In such a case, the second write gap layer 215 may include nonmagnetic nickel. The second write gap layer 215 is nonmagnetic and has better structure for use as a seed layer for NiFe. Consequently, the performance of the P2 218 may also be improved by use of the second gap layer 215 in conjunction with the BARC layer 214.

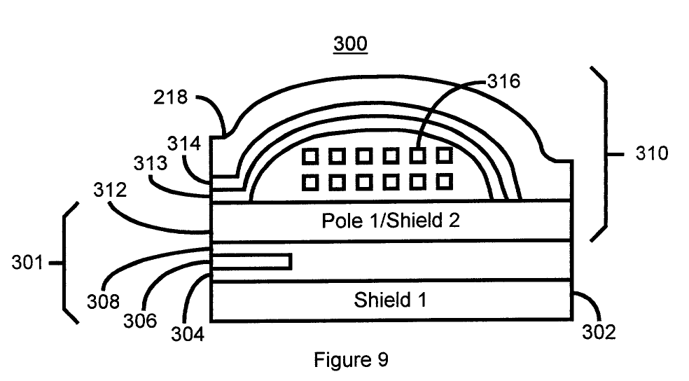

FIG. 9 depicts a side view of another embodiment of a write head 310 in accordance with the present invention. The write head 310 is part of a merged head 300 which includes the write head 310 and a read head 301. The read head 301 includes a first shield 302, a first gap 304, a read sensor 306, a second gap 308, and the first pole/second shield (P1/S2) 312. The P1/S2 312 is also part of the write head 310. The write head 310 also includes a first write gap layer 313, a bottom antireflective coating (BARC) layer 314, a second pole (P2) 318, and at least one coil 316. The BARC layer 314 is a conductive, nonmagnetic layer. In the write head 310 shown, the BARC layer 314 can reduce or eliminate reflections during processing. In addition, the BARC layer 314 can function as part of the write gap during use of the write head 310. The first write gap layer 313 also functions as part of the write gap during use of the write head 310. Thus, the first write gap layer 313 is nonmagnetic and preferably conductive. In the write head 310, the BARC gap layer 314 may also act as the seed layer for the P2 318. Thus, in a preferred embodiment, the BARC layer 314 has the desired crystal structure to be used as a seed layer for the P2 318. In a preferred embodiment, the BARC layer 314 is TiN. In an alternate embodiment, WN_{X} might be a suitable material for the BARC layer 314.

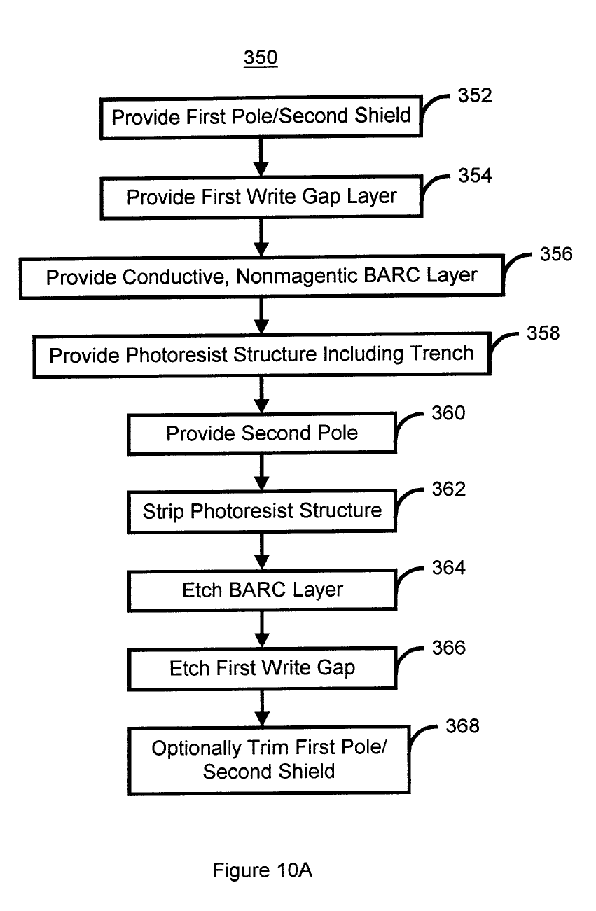

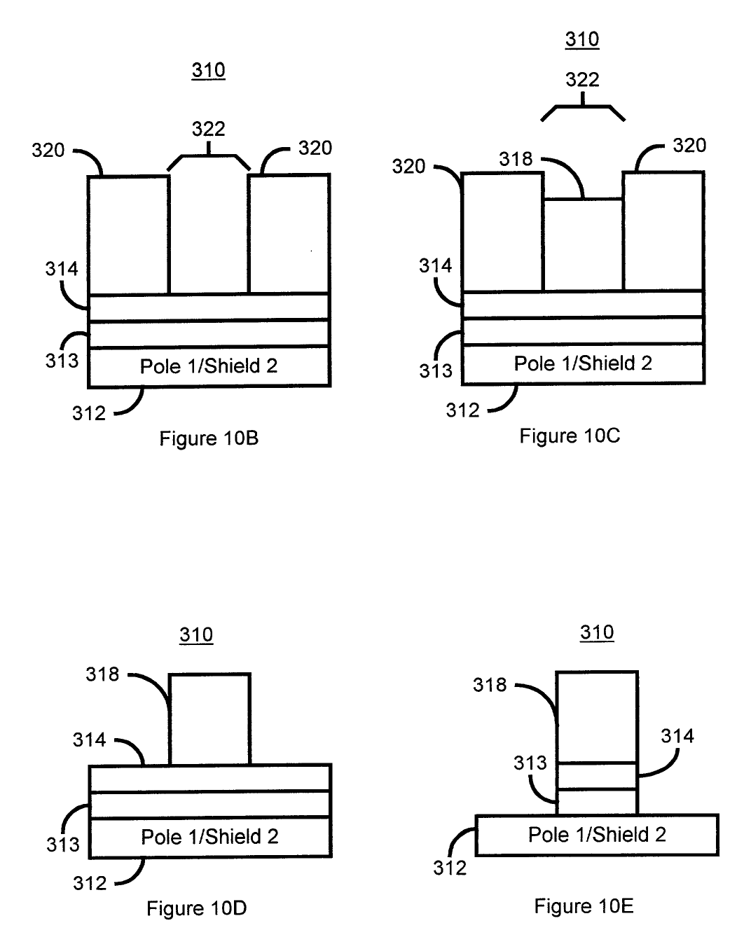

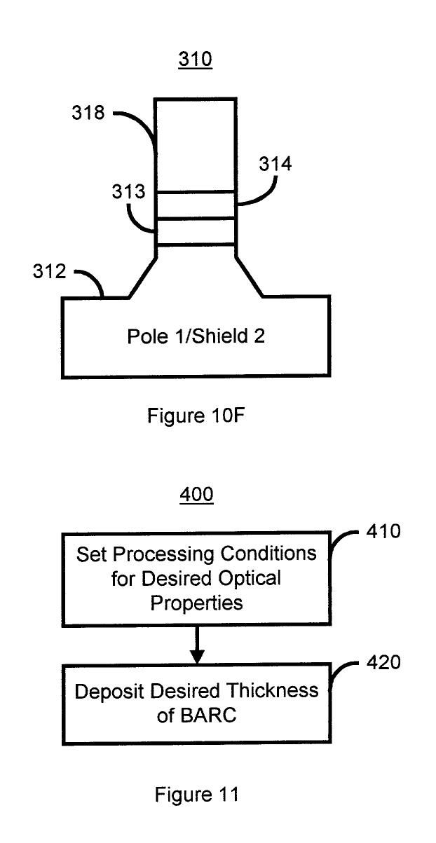

One embodiment of a method for forming the write head 310 will be described in conjunction with FIGS. 10A-10F. FIG. 10A is a flow chart depicting one embodiment of a method 350 for providing the write head 310. FIGS. 10B-10F depict an air bearing surface view of the write head 310 at various points during fabrication. Referring to FIG. 10A, the P1/S2 (first pole/second shield) 312 is provided via step 352. Preferably, the P1/S2 312 is plated in step 352. The first write gap layer 313 is then provided, via step 354. The first write gap layer 313 could be either conductive or nonconductive. The BARC layer 314 is provided, via step 356. The BARC layer 314 is preferably deposited in step 354. The BARC layer 314 provided in step 356 preferably has the optical characteristics and thickness to substantially minimize reflections. A photoresist structure including a trench is then provided, via step 358. Preferably, the photoresist structure is provided by spinning a layer of photoresist onto the BARC layer 314 and developing the trench using photolithography.

FIG. 10B depicts the write head 310 after step 358 has been performed. The photoresist structure 320 including the trench 322 is above the P1/S2 312, the first write gap layer 313, and the BARC layer 314. The BARC layer 314 is preferably TiN. The BARC layer 314 reduces or eliminates reflections from the portions of the write head 310 under the photoresist structure 320. The BARC layer 314 preferably accomplishes this by having the appropriate optical properties and thickness to allow for destructive interference from light reflected off of the top surface of the BARC layer 314 and light reflected off of the bottom surface of the BARC layer 314. Because the BARC layer 314 reduces the light reflected from the portions of the write head 310 under the photoresist structure 320, the variations in the width of the trench due to resist notching or the swing curve effect can be reduced or eliminated.

Referring back to FIG. 10A, the P2 318 is then provided, via step 360. In a preferred embodiment, the P2 318 is plated onto the BARC layer 314. In the write head 310, therefore, the BARC layer 314 has an appropriate structure for acting as the seed layer for the P2 318. The photoresist structure 320 is then stripped, via step 362. FIGS. 10C and D depict the write head 310 after the P2 318 has been deposited and after the photoresist structure 320 has been stripped, respectively.

Referring back to FIG. 10A, the BARC layer 314 and first gap layer 313 are then etched, via step 364. In a preferred embodiment step 364 is performed using RIE. The first write gap 313 is etched via step 366. The P1/S2 312 may then be optionally trimmed, via step 368. FIGS. 10E and 10F depict the write head 310 without trimming and with trimming, respectively. Because the BARC layer 314 is used, the variations in the width of the P2 218 due to resist notching and the swing curve effect can be substantially reduced or eliminated. Thus, the track width for the write head 310 in accordance with the present invention is better controlled.

Use of the first write gap layer 313 may have multiple benefits. The first write gap layer 313 in conjunction with the BARC layer 314 may improve performance of the write head 310 by providing a write gap having the desired thickness along with the benefits of use of the conductive, nonmagnetic BARC layer 314. Because the first write gap layer 313 is provided, the total thickness of the write gap, which includes the first write gap layer 313 and the BARC layer 314, may be better optimized and closer to the desired thickness. At the same time, the reflections may be further reduced by the BARC layer 314. In other words, the thickness of the write gap and the thickness of the BARC layer 314 as well as the reduction in reflections and the attendant reduction in variations in the width of the P2 318 may be improved simultaneously. These benefits are achieved because the BARC layer 314 can be provided at a thickness which reduces reflections as desired while the first write gap layer 313 can be used to provide a write gap having a desired thickness. Thus, variations in the width of the P2 318 may be reduced at the same time that a more optimal write gap thickness is provided. Furthermore, as discussed above, the BARC layer 314, which may be made of TiN or another suitable conductive, nonmagnetic material, can be plated on, allowing the P2 318 to be more easily provided. In addition, when TiN is used for the BARC layer 314, the BARC layer 314 can be more easily etched using reactive ion etching. Thus processing is further simplified.

In addition, the first gap layer 313 can be either a conductor or an insulator. An insulator may be desired to be used for the first gap layer 313 because write gaps are traditionally insulating. If, however, the first write gap layer 313 is a conductor, fabrication of the write head 110 may be facilitated. A conductive first write gap layer 313 will be capable of carrying current, allowing excess charge to be moved during plating of subsequent layer(s). Thus, the first write gap layer 313 may also improve fabrication of the write head 110.

FIG. 11 depicts a flow chart of a method 400 which can be used for providing the BARC layer 114, 214, or 314. The processing conditions are set for the desired optical properties, via step 410. The desired optical properties include the desired extinction coefficient, k, and the desired index of refraction. Generally, these properties can be altered by altering the conditions under which the BARC layer 114, 214, or 314 is grown. The desired thickness of the BARC layer 114, 214, or 314 is then deposited, via step 420.

Preferably, the desired thickness of the BARC layer 114, 214, or 314 is between one hundred and two thousand Angstroms thick. Because the BARC layer 114, 214, or 314 can be deposited, rather than spun on, the thickness of the BARC layer 114, 214, or 314 may be more even over the topography across the wafer. The desired thickness may be one which provides optimal reduction of reflections. The desired thickness may also be one which is optimal for the combination of reduction of reflections and the desired thickness of the write gap. Even if the optimal thickness is not provided, the reflection should be reduced from the reflections present in the absence of the BARC layer 114, 214, or 314.

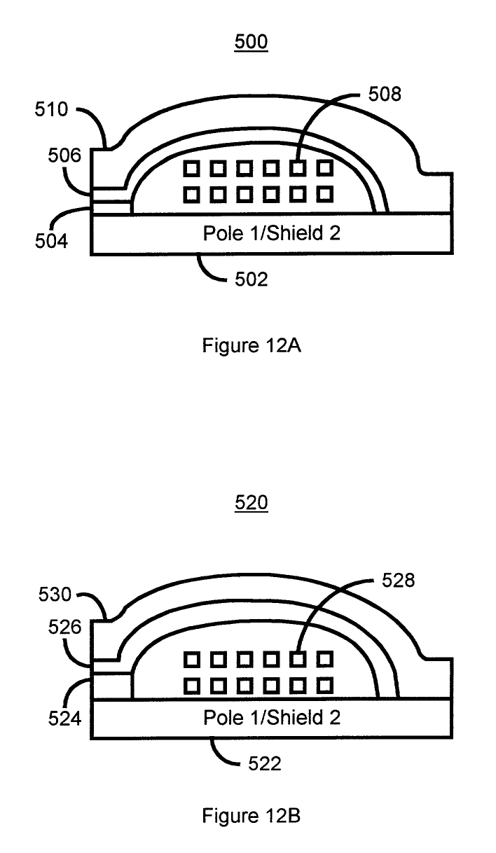

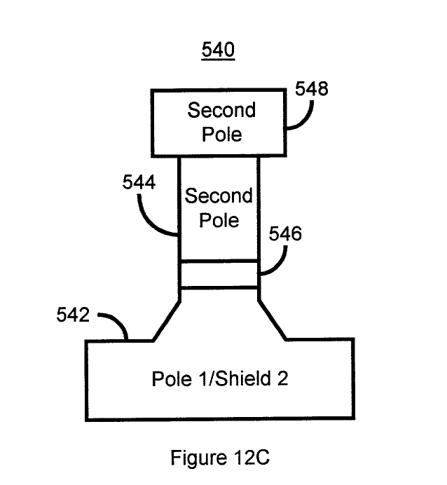

The present invention can be used in a variety of configurations of write head. FIGS. 12A through 12C depict some configurations of write heads 500, 520, and 540 with which the present invention can be used. Referring to FIG. 12A, a side view of a write head 500 including a conductive, nonmagnetic BARC layer 506 that also acts as a write gap is shown. The write head 500 also includes a P1/S2 502 having a pedestal 504. The write head 500 also includes coils 508 and a P2 510. The bottom layer of the coil 508 can be completely below or above the level of the BARC layer 506 or about the same level as the BARC layer 506. Referring to FIG. 12B, a side view of a write head 520 including a conductive, nonmagnetic BARC layer 526 is shown. The write head 520 also includes a P1/S2 522 having a pedestal 524, coils 528, and a P2 530. The first layer of the coil 528 is below the nonmagnetic BARC layer 526. The insulating layer 524 could also be above the BARC layer 526, which functions as the write gap. Referring to FIG. 12C, an air bearing surface view of a write head 540 including a conductive, nonmagnetic BARC layer 546 is shown. The BARC layer 546 also acts as a write gap. The write head 540 also includes a P1/S2 542, coils (not shown), and a stitched second pole having two pieces 544 and 548. The BARC layer 546 may be only under the pole tip 544 or under the pole tip 544 as well as the yoke (not shown). Although not depicted, the BARC layers 506, 526, and 546 could be replaced by a first gap layer and a BARC layer or a BARC layer and a second gap layer. Thus, other configurations of heads can have a better controlled track width due to a better controlled width of the second pole provided by a BARC layer 516, 526, and 546. In addition, processing of the heads 500, 520, and 540 can be simplified, as discussed above with respect to the write heads 110, 210, and 310. Furthermore, the benefits provided by the combinations of the first or second write gap layers and the BARC layers can be provided in the heads 500, 520, and 540.

A method and system has been disclosed for providing a write head having a track width which may be better controlled during processing. Furthermore, processing may be simplified while the write gap may also be optimized. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for writing magnetic data comprising:
a first pole;
a conductive, nonmagnetic bottom antireflective coating (BARC) layer, a portion of the BARC layer disposed above the first pole; and
a second pole, a portion of the second pole disposed above the portion of the BARC layer.

2. The system of claim 1 wherein the BARC layer further includes TiN or WN.

3. The system of claim 1 wherein the portion of the second pole disposed above the portion of the BARC layer is on the portion of the BARC layer and wherein the portion of the BARC layer acts as a seed layer for the portion of the second pole.

4. The system of claim 1 further comprising:
a second gap layer, a portion of the second gap layer disposed between the BARC layer and the second pole.

5. The system of claim 1 further comprising:
a second gap layer, a portion of the second gap layer disposed between the BARC layer and the first pole.

6. The system of claim 5 wherein the second gap layer is a conductive layer.

7. The system of claim 5 wherein the second gap layer is an insulating layer.

8. A method for providing a write head comprising the steps of:
(a) providing a first pole;
(b) providing a conductive, nonmagnetic bottom antireflective coating (BARC) layer, a portion of the BARC layer disposed above the first pole;
(c) providing a photoresist structure having a trench therein; and
(d) providing a second pole, a portion of the second pole disposed above the portion of the BARC layer and within the trench in the photoresist structure.

9. The method of claim 8 further wherein the photoresist providing step (c) further includes the steps of:
(c1) providing the resist structure having the trench therein, the trench having a width, the trench being provided after the BARC layer has been provided and before the second pole has been provided.

10. The method of claim 9 wherein the second pole providing step (d) further includes the steps of:
(d1) depositing the second pole in the trench.

11. The method of claim 8 wherein the BARC layer further includes TiN or WN.

12. The method of claim 8 wherein the portion of the second pole disposed above the portion of the BARC layer is on the portion of the BARC layer and wherein the portion of the BARC layer acts as a seed layer for the portion of the second pole.

13. The method of claim 8 further comprising the step of:
(e) providing a second gap layer, a portion of the second gap layer disposed between the BARC layer and the second pole.

14. The method of claim 8 further comprising the step of:
(e) providing a second gap layer, a portion of the second gap layer disposed between the BARC layer and the first pole.

15. The method of claim 14 wherein the second gap layer is a conductive layer.

16. The method of claim 14 wherein the second gap layer is an insulating layer.

17. The method of claim 8 wherein the write head is part of a merged head.
